(19) United States
(12) Patent Application Publication
(10) Pub. No.: US 2006/0267906 A1
(43) Pub. Date: Nov. 30, 2006

(54) Discharging circuit and driving circuit of liquid crystal display panel using the same

(75) Inventor: De-Ching Shie, Santa Clara, CA (US)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/442,921

(22) Filed: May 30, 2006

(30) Foreign Application Priority Data
May 27, 2005 (CN) 094117376

(51) Int. Cl. G09G 3/36

(52) U.S. Cl. 345/98

(57) ABSTRACT

A discharging circuit includes a first switch, a second switch, and a third switch. The first switch and the second switch respectively have three terminals. The first terminal of the first switch is coupled with the discharging system, and the second terminal of the first switch is grounded. The third terminal of the first switch is coupled with the first terminal of the second switch. The first terminal of the second switch is coupled with the third terminal of the first switch, and the second terminal of the second switch is coupled with the third switch and a grounded capacitor. The third terminal of the second switch is connected with a power supply. When the power supply is turned on, the third switch is turned on and the capacitor is charged. When the power supply is turned off, the first switch and the second switch are turned on because of voltage of the capacitor.

### FIELD OF THE INVENTION

The present invention relates to a discharging circuit and a driving circuit of a liquid crystal display using the discharging circuit, wherein the discharging circuit is for discharging residual charges.

### GENERAL BACKGROUND

After a typical liquid crystal display has been turned off for a period of time, residual charges remain on a panel of the liquid crystal display. Residual images or flickering of a display screen of the liquid crystal display may be generated because of the residual charges. Generally, it is only when a voltage of the residual charges falls below a certain threshold that the liquid crystal display panel no longer exhibits abnormalities related to the residual charges. Thus, a discharging circuit is needed for discharging residual charges after the liquid crystal display is turned off.

FIG. 2 is a schematic of a thin-film transistor liquid crystal display (TFT-LCD) panel 1 and a driving circuit 2 of a conventional TFT-LCD. The driving circuit 2 includes a gate driver 21, a source driver 23, and a discharging circuit 25. The gate driver 21 and the source driver 23 are positioned in the vicinity of the TFT-LCD panel 1, and the gate driver 21 includes a gate driving line 211 and a diode 213. The gate driver 21 is coupled with an anode of the diode 213 through the gate driving line 211, and a cathode of the diode 213 is used to receive gate electrode driving signals. In addition, the gate driving line 211 is coupled with a common electrode line (not shown) through a storage capacitor 215. A power voltage VDD is connected with the gate driving line 211 to power the TFT-LCD panel 1. The discharging circuit 25 includes a resistor 255. One terminal of the resistor 255 is coupled with the gate driving line 211 and the other terminal of the resistor 225 is grounded.

When the TFT-LCD panel 1 is turned on, the power voltage VDD is supplied to the gate driving line 211 and the storage capacitor 215 maintains a voltage of each of pixels (not shown) of the TFF-LCD panel 1 during a period of one display frame. Thus the TFT-LCD panel 1 displays a normal image. When the TFT-LCD panel 1 is turned off, the power voltage VDD is not supplied, and residual charges of the TFT-LCD panel 1 are discharged to ground through the resistor 255.

The resistor 255 is thus used to discharge residual charges of the TFT-LCD panel 1. In one example, when a resistance of the resistor 255 is 100,000 ohms and the power voltage is 10 volts, the time needed for discharge is 4.18 seconds. If the resistance of the resistor 255 is less than 100,000 ohms, then the time of discharge is less than 4.18 seconds but the power consumption is higher. In the example, when the resistance of the resistor 255 is 100,000 ohms, the power consumption is 1.05 milliwatts. In contrast, when the resistance of the resistor 255 is 10,000 ohms, the power consumption is 105 milliwatts. That is, when the resistance is smaller, the consumption of power is higher; and when the resistance is larger, the time of discharge is longer. It is difficult to achieve both low power consumption and a fast discharge time for the TFT-LCD panel 1.

Accordingly, what is needed is a discharging circuit of a liquid crystal display panel with a short time of discharge and low power consumption.

### SUMMARY

A discharging circuit coupled with a discharging system is provided. The discharging circuit includes a first switch, a second switch, and a third switch. The first switch and the second switch respectively include three terminals. The first terminal of the first switch is coupled with the discharging system, and the second terminal of the first switch is grounded. The third terminal of the first switch is coupled with the first terminal of the second switch. The first terminal of the second switch is coupled with the third terminal of the first switch, and the second terminal of the second switch is coupled with the third switch and a grounded capacitor. The third terminal of the second switch is connected with a power supply. One terminal of the third switch is coupled with the second terminal of the second switch, and the other terminal of the third switch is connected with the power supply. When the power supply is turned on, the third switch is turned on and the capacitor is charged so that discharging circuit electrically disconnects with the discharging system. When the power supply is turned off, the first switch and the second switch are turned on because of voltage of the capacitor so that the charges are discharged to ground through the first terminal of the discharging system.

A driving circuit of a liquid crystal display panel includes a driving device and a discharging circuit. The driving device receives driving signals through the driving lines and is coupled with the discharging circuit. The discharging circuit includes a first switch, a second switch and a third switch. The first switch and the second switch respectively include three terminals. The first terminal of the first switch is coupled with the driving device, and the second terminal of the first switch is grounded. The third terminal of the first switch is coupled with the first terminal of the second switch. The first terminal of the second switch is coupled with the third terminal of the first switch, and the second terminal of the second switch is coupled with the third switch and a grounded capacitor. The third terminal of the second switch is connected with a power supply. One terminal of the third switch is coupled with the second terminal of the second switch, and the other terminal of the third switch is connected with the power supply. When the power supply is turned on, the third switch is turned on and the capacitor is charged so that discharging circuit electrically disconnects with the driving device. When the power supply is turned off, the first switch and the second switch are turned on because of voltage of the capacitor so that the charges are discharged to ground through the first terminal of the discharging system.

As described above, the discharging circuit of the liquid crystal display panel has three switches. When the power supply is turned on, the discharging circuit is electrically disconnected and does not consume power. When the power supply is turned off, the discharging circuit is turned on and residual charges are directly discharged to ground by conductive wires.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic of a thin-film transistor liquid crystal display (TFT-LCD) panel and discharging circuit in accordance with a preferred embodiment of the present invention; and

FIG. 2 is a schematic of a conventional TFT-LCD panel and discharging circuit.

### DETAILED DESCRIPTION OF PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims and equivalents thereof.

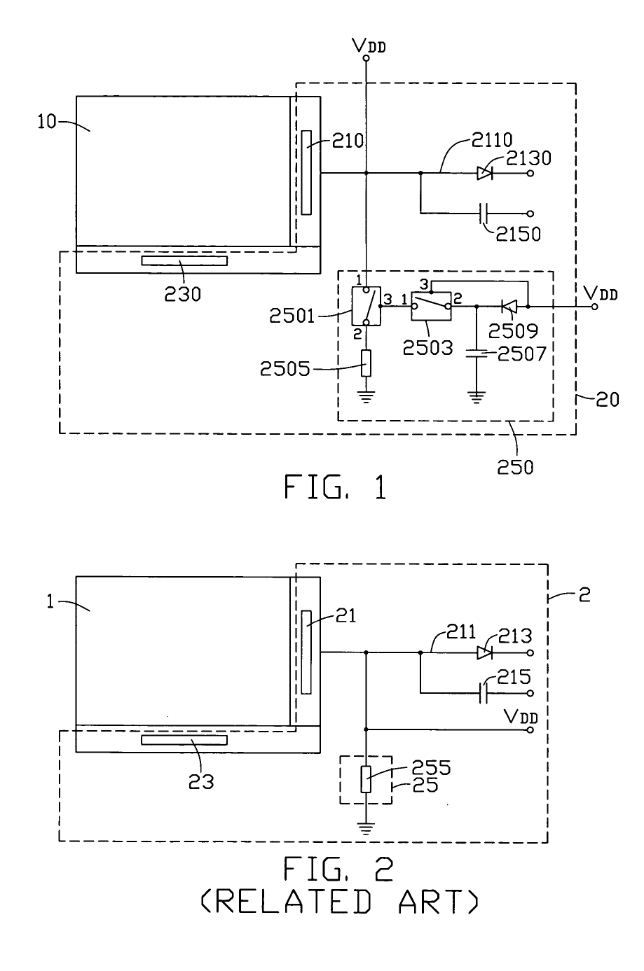

FIG. 1 is a schematic of a thin-film transistor liquid crystal display (TFT-LCD) panel 10 and a driving circuit 20 in accordance with a preferred embodiment of the present invention. The driving circuit 20 includes a gate driver 210, a source driver 230, and a discharging circuit 250. The gate driver 210 and the source driver 230 are positioned in the vicinity of the TFT-LCD panel 10, and the gate driver 210 includes a gate driving line 2110 and a diode 2130. The gate driving line 2110 is coupled with an anode of the diode 2130, and a cathode of the diode 2130 is used to receive gate electrode driving signals. In addition, the gate driving line 2110 is coupled with a common electrode line (not shown) through a storage capacitor 2150.

A power voltage VDD is supplied to the gate driving line 2110 through the discharging circuit 250. The discharging circuit 250 includes a first transistor 2501, a second transistor 2503, a capacitor 2507, and a diode 2509. Typically, the first transistor 2501 is a negative-positive-negative (NPN) type transistor, and the second transistor 2503 is a positive-negative-positive (PNP) type transistor. A first terminal of the first transistor 2501 is coupled with the gate driving line 2110, and a second terminal of the first transistor 2501 is grounded through a resistor 2505. A third terminal of the first transistor 2501 is coupled with a first terminal of the second transistor 2503. A second terminal of the second transistor 2503 is coupled with a cathode of the diode 2509 and a first end of the capacitor 2507, and a third terminal of the second transistor 2503 and an anode of the diode 2509 are coupled with the power voltage VDD. A second end of the capacitor 2507 is grounded.

When the power voltage VDD is turned on, the first transistor 2501 and the second transistor 2503 are turned off; but power is still supplied to the gate driving line 2110, and the storage capacitor 2150 maintains a voltage of each of pixels (not shown) of the TFT-LCD panel 10 during a period of one display frame. Thus, the diode 2509 is turned on so that the capacitor 2507 is charged.

When the power voltage VDD is turned off, the first terminal and the second terminal of the second transistor 2503 are turned off, and the first terminal and the second terminal of the first transistor 2501 are turned on because the capacitor 2507 has stored charge. Residual charges on the TFT-LCD panel 10 are discharged to ground. In addition, the residual charges are discharged through the resistor 2505 so that the driving circuit 20 is protected.

Because the first transistor 2501 and the second transistor 2503 are used as switches for the discharging circuit 250, residual charges on the TFT-LCD panel 10 are efficiently discharged. When the system has no power, the second transistor 2503 is turned on and the first transistor 2501 is grounded. Experiments have indicated that if the power voltage is 10 volts and the discharging circuit 250 is utilized, a resistance of the resistor 2505 can be less than that of conventional resistors and a time of discharge is approximately 77.6 milliseconds. The discharge time can be much faster than that of a conventional discharging circuit such as the discharging circuit 25 described above.

In summary, the discharging circuit 250 includes the diode 2509 and the capacitor 2507. When the power voltage VDD is supplied, power consumption is substantially zero. However, in the above-described conventional discharging circuit 25, when the resistance of the resistor 255 is 100 ohms and the voltage is 10 volts, then the power consumption is 1.05 milliwatts. That is, the present invention consumes little or no power.

The discharging circuit 250 is able to not only be used to discharge residual charges of the TFT-LCD panel 10, but can also be implemented in various other electronic devices, appliances and systems. The discharging circuit 250 advantageously discharges residual charges fast, while consuming little or no power of the associated electronic device, appliance or system.

In an alternative embodiment of the discharging circuit 250, the diode 2509 can be replaced by a transistor. In such case, when the power supply is turned on, the capacitor 2507 is charged and the first transistor 2501 and the second transistor 2503 are turned off. When the power supply is turned off, the first transistor 2501 and the second transistor 2503 are turned on.

While the invention has been described by way of examples and in terms of the preferred embodiments, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A discharging circuit, coupled with a discharging system, the circuit comprising:
a first switch, a second switch and a third switch, the first switch and the second switch respectively including three terminals, and the first terminal of the first switch coupled with the discharging system, the second terminal of the first switch being grounded and the third terminal of the first switch coupled with the first terminal of the second switch, and the first terminal of the second switch coupled with the third terminal of the first switch and the second terminal of the second switch coupled with the third switch and a grounded capacitor, and the third terminal of the second switch connected with a power supply, and one terminal of the third switch coupled with the second terminal of the second switch and the other terminal of the third switch connected with the power supply;
wherein the third switch is turned on and the capacitor is charged when the power supply is turned on so that discharging circuit electrically disconnects with the discharging system; and
the first switch and the second switch are turned on because of voltage of the capacitor when the power supply is turned off so that the charges are discharged to ground through the first terminal of the discharging system.

2. The discharging circuit as claimed in claim 1, wherein the first switch is a transistor, and if the power supply is turned on, then the first switch is turned off, and if the power supply is turned off, then the first switch is turned on.

3. The discharging circuit as claimed in claim 2, wherein the first switch is a negative-positive-negative (NPN) type transistor.

4. The discharging circuit as claimed in claim 1, wherein the second switch is a transistor, and if the power supply is turned on, then the first switch is turned off, and if the power supply is turned off, then the first switch is turned on.

5. The discharging circuit as claimed in claim 4, wherein the first switch is a positive-negative-positive (PNP) type transistor.

6. The discharging circuit as claimed in claim 1, wherein the third switch is a diode, and an anode of the third switch is coupled with the power supply and the a cathode of the third switch is coupled with the second terminal of the second switch.

7. The discharging circuit as claimed in claim 1, wherein the second terminal of the first switch is grounded through a resistor.

8. A driving circuit of a liquid crystal display panel, comprising:
a discharging circuit; and
a driving device, used to receive driving signals through driving lines and coupled with the discharging circuit;
wherein the discharging circuit includes a first switch, a second switch and a third switch and the first switch and the second switch respectively include three terminals, and the first terminal of the first switch is coupled with the driving device, the second terminal of the first switch is grounded and the third terminal of the first switch is coupled with the first terminal of the second switch, and the first terminal of the second switch is coupled with the third terminal of the first switch, and the second terminal of the second switch is coupled with the third switch and a grounded capacitor, the third terminal of the second switch is connected with a power supply, and one terminal of the third switch is coupled with the second terminal of the second switch and the other terminal of the third switch is connected with the power supply;
the power supply is turned on, the third switch is turned on and the capacitor is charged so that discharging circuit electrically disconnects with the driving device; and
the power supply is turned off, the first switch and the second switch are turned on because of voltage of the capacitor so that the charges are discharged to ground through the first terminal of the discharging system.

9. The driving circuit of a liquid crystal display panel as claimed in claim 8, wherein the first switch is a transistor, and if the power supply is turned on, then the first switch is turned off, and if the power supply is turned off, then the first switch is turned on.

10. The driving circuit of a liquid crystal display panel as claimed in claim 9, wherein the first switch is a positive-negative-positive (PNP) type transistor.

11. The driving circuit of a liquid crystal display panel as claimed in claim 8, wherein the second switch is a transistor, and if the power supply is turned on, then the first switch is turned off, and if the power supply is turned off, then the first switch is turned on.

12. The driving circuit of a liquid crystal display panel as claimed in claim 11, wherein the first switch is a positive-negative-positive (PNP) type transistor.

13. The driving circuit of a liquid crystal display panel as claimed in claim 8, wherein the third switch is a diode, and an anode of the third switch is coupled with the power supply and the a cathode of the third switch is coupled with the second terminal of the second switch.

14. The driving circuit of a liquid crystal display panel as claimed in claim 8, wherein the second terminal of the first switch is grounded through a resistor.
